(19) United States
(12) Patent Application Publication
(10) Pub. No.: US 2005/0042508 A1
(43) Pub. Date: Feb. 24, 2005

(54) Secondary battery

(76) Inventors: Chang-Seob Kim, Cheonan-si (KR); Su-Jin Han, Cheonan-si (KR)

Correspondence Address: CHRISTIE, PARKER & HALE, LLP, PO BOX 7068, PASADENA, CA, 91109-7068, US

(21) Appl. No.: 10/923,125

(22) Filed: Aug. 19, 2004

(30) Foreign Application Priority Data
Aug. 21, 2003 (KR) 2003-0057967

(51) Int. Cl. H01M 2/08; H01M 2/02

(52) U.S. Cl. 429/174; 429/176; 429/185

(57) ABSTRACT

A secondary battery includes an electrode assembly with a positive electrode plate, a negative electrode plate, and a separator disposed between the positive and the negative electrode plates. A can in which the electrode assembly is mounted has an opening portion. A cap assembly is mounted at the opening portion of the can to seal the can. The cap assembly has a cap plate fitted to the opening portion of the can, and the hardness of the can is greater than the hardness of the cap plate.

### CROSS-REFERENCE TO RELATED APPLICATION

This application claims the benefit of and priority to Korean Patent Application No. 2003-57967 filed on Aug. 21, 2003 in the Korean Intellectual Property Office, the entire disclosure of which is incorporated herein by reference.

### BACKGROUND

(a) Field of the Invention

The present invention relates to batteries, and in particular, to a secondary battery which has a can mounting an electrode assembly therein.

(b) Description of Related Art

Generally, a secondary battery has an electrode assembly that operates as an electric generation unit, with a positive electrode plate, a negative electrode plate, and a separator. The electrode assembly is mounted within a can, and an electrolyte is injected into the can. The can is hermetically sealed at its opening portion by using a cap assembly.

Such secondary batteries also frequently include an electrode terminal formed at the cap assembly while being insulated from the can. The electrode terminal forms a pole, and the battery can itself is operated as an opposite pole.

With the above-structured secondary battery, the recent trend is that the can is formed with aluminum or an aluminum alloy, which has a lighter weight than iron or other conductive metallic materials, and is not corroded even with long-term usage under a high voltage environment. That is, the aluminum-based battery provides excellent performance characteristics.

The cap assembly for hermetically sealing the opening portion of the can in these batteries typically includes a cap plate directly welded to the opening portion of the can to seal it, a terminal pin penetrating the cap plate, and a gasket insulating the terminal pin from the cap plate. The cap plate and the can are typically formed with the same material to facilitate proper welding thereof.

Furthermore, a safety vent is provided at the cap plate. When the inner pressure of the battery exceeds a predetermined value, the vent is ruptured and operated to reduce the battery inner pressure and to make the battery explosion-proof. The vent can be made by forming a groove at the cap plate with a predetermined depth using a mechanical technique, an etching technique, or an electroforming technique, by partially reducing the thickness of the grooved portion of the cap plate.

However, with the above-structured secondary battery, the electrode assembly is repeatedly swelled and shrunken during the charging and discharging, and the can is swelled together with the swelling of the electrode assembly. This is called the swelling phenomenon.

Several efforts have been recently made to prevent the swelling phenomenon, and in this connection, it is proposed that the can should be formed with a high hardness alloy.

However, when the cap plate and the can are formed with the same material, it is not easy to properly control the operational pressure of the safety vent formed at the cap plate in a stable manner. Furthermore, the stress to the vent is decreased due to annealing and other factors, and it becomes difficult to enhance the impact resistance of the vent.

### SUMMARY

In accordance with the present invention, a secondary battery is provided which effectively prevents the safety vent from being abnormally operated while avoiding the swelling phenomenon.

An exemplary secondary battery according to one embodiment of the present invention includes an electrode assembly with a positive electrode plate, a negative electrode plate, and a separator disposed between the positive and the negative electrode plates. The electrode assembly is mounted within a can through an opening portion of the can. A cap assembly is mounted at the opening portion of the can to seal the can, and the cap assembly has a cap plate fitted to the opening portion of the cap, the hardness of the cap being higher than the hardness of the cap plate.

The cap plate may be formed with Al or an Al alloy.

The can may be formed with a material where 0.35 wt % of one or more metallic elements selected from the group consisting of Mn, Mg, Si, Zr, Ti, and Cu are added to a base metal. The base metal may be Al or an Al alloy. The base metal may be the same as the material for forming the cap plate.

The cap plate is welded to the can using a laser welding technique.

### BRIEF DESCRIPTION OF THE DRAWINGS

FIG. 1 is an exploded perspective view of a secondary battery according to an embodiment of the present invention.

FIG. 2 is a side view of the secondary battery shown in FIG. 1 in a combined state.

### DETAILED DESCRIPTION OF EXEMPLARY EMBODIMENTS

The present invention will be described more fully hereinafter with reference to the accompanying drawings, in which exemplary embodiments of the invention are shown.

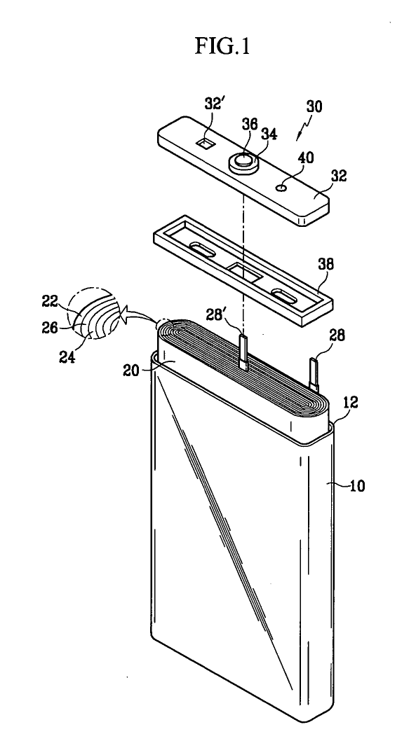

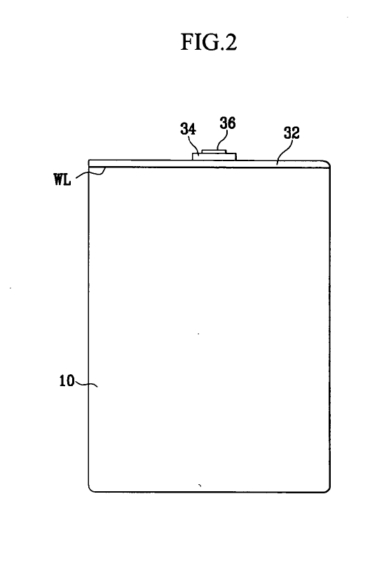

As shown in FIGS. 1 and 2, the secondary battery according to one embodiment of the present invention has a substantially rectangular shape, and includes a can 10 with an opening portion 12 at one side, an electrode assembly 20 mounted within the can 10 through the opening portion 12, and a cap assembly 30 sealing the opening portion 12 of the can 10.

The electrode assembly 20 has a positive electrode plate 22, a negative electrode plate 24, and a separator 26 disposed between the positive and the negative electrode plates 22 and 24. As shown in FIG. 1, the positive and the negative electrode plates 22 and 24 interposing the separator 26 are rolled as with the conventional spiral wound- or “jelly roll”-type batteries.

With the electrode assembly 20, the electrode plate 24 has a negative electrode current collector, which is formed with a strip-shaped copper thin plate. A negative electrode coating film is formed on one side surface of the negative electrode current collector. The negative electrode coating film is coated with a negative electrode mixture containing a negative electrode active material. A carbonic material is used as the negative electrode material, and a binder, a plasticizer, and a conductor are added thereto to make the negative electrode mixture.

The positive electrode plate 22 has a positive electrode current collector, which is formed with a strip-shaped metallic thin plate. An aluminum thin plate may be used as the positive electrode current collector. A positive electrode coating film is formed on one side surface of the positive electrode current collector. The positive electrode coating film is coated with a positive electrode mixture containing a positive electrode active material. A lithium-based oxide is used as the positive electrode material, and a binder, a plasticizer, and a conductor are added thereto to make the positive electrode mixture.

Positive and negative electrode tabs 28 and 28′ are drawn out from the electrode assembly 20 while being electrically connected to the positive and the negative electrode plates 22 and 24, respectively. A nickel thin film forms the negative electrode tab 28′, and an aluminum thin film forms the positive electrode tab 28 in this embodiment.

The positive and negative electrode tabs 28 and 28′ shown in FIG. 1 may be altered in their material and locations.

Meanwhile, the can 10 is formed with a metallic material roughly in the shape of a rectangular parallelepiped. Accordingly, the can 10 may itself function as a terminal. Furthermore, the can 10 has an opening portion 12, through which the electrode assembly 20 is inserted into the can 10.

The edges of the can 10 may be square-shaped, or rounded.

In this embodiment, the can 10 is formed with a light-weight conductive material, such as an Al alloy. The can 10 may be formed with a high hardness Al alloy. The high hardness Al alloy is formed by adding 0.35 wt % of one or more hardness-enhancing metallic elements selected from Mn, Mg, Si, Zr, Ti, or Cu to the base metal of Al.

The can 10 based on the high hardness Al alloy prevents the swelling phenomenon with a relatively thin thickness, and effectively serves to make the battery thinner and lighter.

A cap assembly 30 is mounted at the opening portion 12 of the high hardness Al alloy-based can 10 of this embodiment. The cap assembly 30 has a cap plate 32 directly welded to the opening portion 12 of the can 10 to seal the cap 10.

The cap plate 32 is formed with Al or an Al alloy, which has a hardness lower than that of the can 10. This is to properly control the operational pressure of the safety vent 32′ formed at the cap plate 32 in a stable manner, and to reduce the stress to the safety vent 32′ through the heat treatment of annealing, thereby enhancing the impact resistance. The material of A3003 (standard name of material) where the alloy elements of 0.3 wt % of Si, 0.55 wt % of Fe, 0.12 wt % of Cu, and 1.0 wt % of Mn are added to the metal of Al may be used to form the cap plate 32.

The safety vent 32′ is made by forming a groove at the cap plate 32 with a predetermined depth, and making the grooved portion of the cap plate 32 thinner than other portions thereof.

A terminal pin 36 is formed at the cap plate 32 while penetrating the cap plate 32 such that it is insulated from the latter by interposing a gasket 34. An insulating plate (not shown) and a terminal plate (not shown) are further formed under the terminal pin 36 to insulate it from the cap plate 32. The negative electrode tab 28′ drawn out from the negative electrode plate 24 is welded to the terminal pin 36 from the bottom thereof. The terminal pin 36 functions as a negative electrode terminal.

The positive electrode tab 28 drawn out from the positive electrode plate 22 is electrically connected to the bottom surface of the cap plate 32 or to the inner surface of the can 10 such that the entire outer portion of the battery except for the terminal pin 36 functions as a positive electrode terminal. However, the structure of the positive and the negative electrode terminals are not limited thereto. As with the structure of the negative electrode terminal, the structure of the positive electrode terminal may be formed with a separate terminal pin.

When the electrode assembly 20 is mounted within the can 10, a protective case 38 is further formed between the electrode assembly 20 and the cap assembly 30 with an insulating material to fix the electrode assembly 20 more rigidly.

When the cap assembly 30 is welded to the opening portion 12 of the can 10, an electrolyte is injected into the can 10 through an electrolyte injection hole 40 formed at the cap plate 32, which is then sealed by way of a plug (not shown).

With the above-structured square secondary battery, the cap plate 32 is welded to the opening portion 12 of the can 10 to seal it. However, as the cap plate 32 is formed with a material having a hardness lower than that of the can 10 to control the operational pressure of the safety vent 32′, the welding between the two members 10 and 32 is liable to be deteriorated.

Accordingly, in this embodiment, the cap plate 32 is welded to the can 10 along the welding line (WL) shown in FIG. 2, using a laser welding technique. The laser involves a frequency of 100-140 Hz, a power of 200-400 W, and a heat capacity of 2.3-2.5 Joule/spot. The welding speed in this embodiment is 17-25 mm/sec.

With the laser welding process, the can 10 and the cap plate 32 with different levels of hardness can be welded to each other in a stable manner.

As described above, the can 10 mounting the electrode assembly 20 therein is formed with a high hardness material in view of the swelling phenomenon, and the cap plate 32 sealing the opening portion 12 of the can 10 is formed with a low hardness material in view of the operational pressure and the impact resistance of the safety vent 32′. In this way, the battery becomes thinner and lighter while effectively preventing the swelling phenomenon. Furthermore, the operational pressure of the safety vent 32′ can be properly controlled, and the possible abnormal operation of the battery due to the deterioration in the impact resistance of the safety vent 32′ can be prevented.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. A secondary battery comprising:
an electrode assembly with a positive electrode plate, a negative electrode plate, and a separator disposed between the positive and the negative electrode plates;
a can in which the electrode assembly is mounted, the can having an opening portion; and
a cap assembly mounted at the opening portion of the can to seal the can and having a cap plate fitted to the opening portion of the can,
wherein the hardness of the can is greater than the hardness of the cap plate.

2. The secondary battery of claim 1, wherein the cap plate is Al.

3. The secondary battery of claim 1, wherein the cap plate is an Al alloy.

4. The secondary battery of claim 1, wherein the can comprises a base metal and at least one hardness-enhancing metallic element added to the base metal.

5. The secondary battery of claim 4, wherein the at least one hardness-enhancing metallic is selected from the group consisting of Mn, Mg, Si, Zr, Ti and Cu.

6. The secondary battery of claim 4, wherein the at least one hardness-enhancing metallic element is approximately 0.35 wt % of the can.

7. The secondary battery of claim 4, wherein the base metal is Al.

8. The secondary battery of claim 4, wherein the base metal is an Al alloy.

9. The secondary battery of claim 4, wherein the cap plate is the same material as the base metal.

10. The secondary battery of claim 1, wherein the cap plate comprises an Al alloy having around 0.3 wt % of Si, around 0.55 wt % of Fe, around 0.12 wt % of Cu, and around 1.0 wt % of Mn.

11. The secondary battery of claim 1, wherein the cap plate is welded to the can by a laser.

12. The secondary battery of claim 11, wherein a frequency of the laser is around 100-140 Hz.

13. The secondary battery of claim 11, wherein the power of the laser is around 200-400 Watts.

14. The secondary battery of claim 11, wherein the laser has a heat capacity of around 2.3-2.5 Joules/spot.

15. The secondary battery of claim 11, wherein the cap plate is welded to the can at a speed of around 17-25 mm/sec.

16. The secondary battery of claim 1, wherein the battery is substantially rectangular.
